(19) United States
(12) Patent Application Publication
(10) Pub. No.: US 2001/0029445 A1
(43) Pub. Date: Oct. 11, 2001

(54) Device for shaping a signal, notably a speech signal

(76) Inventor: Nabil Charkani, Le Mans (FR)

Correspondence Address: Corporate Patent Counsel, U.S. Philips Corporation, 580 White Plains Road, Tarrytown, NY, 10591, US

(21) Appl. No.: 09/804,020

(22) Filed: Mar. 12, 2001

(30) Foreign Application Priority Data
Mar. 14, 2000 (FR) 0003257

(51) Int. Cl. G10L 19/00; G10L 21/00

(52) U.S. Cl. 704/201

(57) ABSTRACT

The invention relates to a device for shaping a signal, notably a speech signal that occupies a certain frequency band and is attenuated at least on a low part of this frequency band. The invention comprises regenerating the low part of the frequency band by filtering, the filter to be used being determined on the basis of the signal to be regenerated, for example, by applying a vector quantizer selection method.

Applications: receivers of telephony transmission systems which utilize a narrow band lying between 300 Hz and 3400 Hz; audio apparatus that may be subject to an acoustic loss, for example, high impedance loudspeakers.

### FIELD OF THE INVENTION

The invention relates to a transmission system comprising at least a transmitter for transmitting a speech signal in a narrow frequency band, and a receiver for receiving said speech signal.

The invention also relates to a receiver intended to be used in such a transmission system, a speech signal processing method intended to be used in such a receiver, and a computer program comprising means for implementing such a method.

The invention finally relates to a device for shaping an input signal, and in particular a device for shaping a speech signal that occupies a certain frequency band and may be attenuated at least on a low part of said frequency band.

The invention finds highly significant applications for wired or wireless telephony. In a conventional manner, the speech signal, which initially occupies the [100 Hz-7000 Hz] frequency band is filtered at the transmitter end to limit the quantity of data to be transmitted. This filtering leads to an attenuation of the low frequency band (100 Hz-300 Hz) and a loss of the high band (3400 Hz-7000 Hz). The result is a degradation of the quality of the signal.

The invention also relates to audio apparatus hat may be subjected to acoustic loss caused, for example, by the loudspeakers that utilize the technology called high impedance technology. The main drawback of this technology is that when the ear is not close to the loudspeaker, the sound signal is largely attenuated, especially at low frequencies.

### BACKGROUND OF THE INVENTION

U.S. Pat. No. 5,455,888 describes a method of generating a synthesized signal at the receiver end in the missing high frequency band (3400 Hz-7000 Hz). This method comprises the determination of a filter on the basis of the received signal, which filter models the frequency response of the voiced apparatus in the narrow band (300 Hz-3400 Hz). The inverse filter is then applied to the received signal to obtain the corresponding excitation signal in the narrow band. These two components (frequency response of the voiced apparatus and excitation signal) are then widened independently of each other. In particular a vector quantizer technique is used to determine, on the basis of the filter that models the response of the voiced apparatus in the narrow band, a filter which models the response of the voiced apparatus in the wideband (300 Hz-7000 Hz). The extended excitation is then applied to the filter, which models the response of the voiced apparatus in the wideband to obtain a speech signal in the wideband.

This method makes a large number of calculations necessary. It is thus costly in terms of time and resources.

### SUMMARY OF THE INVENTION

It is a first object of the invention to propose a simple method of improving the quality of the received signal. For this purpose, a transmission system according to the invention and as described in the opening paragraph is characterized in that said receiver comprises selection means for selecting a regeneration filter based on the received signal, and means for processing the received signal with said regeneration filter to regenerate a frequency band that is low relative to said narrow band.

The invention benefits from the fact that the low frequencies of the speech signal are attenuated, but are not completely suppressed. The received signal thus contains data about the low part of the band. In accordance with the invention these data are used for determining the filter to be applied for regenerating the low frequency band.

In a first embodiment the characteristics of the regeneration filter are such that the regeneration filter amplifies no frequency whatsoever and delivers a signal that occupies only said low band, and said processing means comprise variable amplifier means for amplifying the signal delivered by the regeneration filter, to produce an unsaturated signal that has maximum dynamic, and combining means of the thus amplified signal and of the signal received in the narrow band to produce a regenerated speech signal. This embodiment is particularly advantageous when a fixed-accuracy processor is used to carry out the calculations because the risk of saturation is particularly noticeable with this type of processors.

In a second embodiment the characteristics of the regeneration filter are such that it amplifies the components of the signal which are contained in said low band, and that it directly generates the regenerated speech signal. This embodiment is more particularly adapted to the use of a floating point processor.

It is a second object of the invention to propose a device for shaping a signal. A device for shaping an input signal in accordance with the invention and as described in the opening paragraph is characterized in that it comprises non-amplifying filter means to deliver a first output signal, and variable amplifier means for amplifying said first output signal as a function of its maximum amplitude, to deliver a second, non-saturated, output signal that has maximum dynamic.

Such a device for shaping a signal offers the advantage to separately process the shape and the gain to be applied to the signal to be reshaped, and thus to permit the control of the gain to obtain maximum dynamic while avoiding saturating the signal. This type of signal shaping device is particularly well suitable for electronic apparatus that utilizes fixed-accuracy processors.

It is a third object of the invention to propose a device for shaping a speech signal that occupies a certain frequency band and may be attenuated at least on a lower part of said frequency band. In accordance with the invention such a device is characterized in that it comprises selection means for selecting a filter based on said speech signal, and processing means for processing said speech signal with said filter to raise a frequency band that is low relative to said narrow band. Such a device is used, for example, in audio apparatus which includes a loudspeaker that operates according to the technology called high impedance technology to shape the signal applied to said loudspeaker.

### BRIEF DESCRIPTION OF THE DRAWINGS

These and other aspects of the invention are apparent from and will be elucidated, by way of non-limitative example, with reference to the embodiment(s) described hereinafter.

In the drawings:

FIG. 1 represents in the shape of function blocks a baseband model of a telephony transmission system,

FIG. 2 represents an example of filter selection means,

FIG. 3 represents an example of a first embodiment of a device in accordance with the invention for shaping a signal,

FIG. 4 represents an example of a second embodiment of a device in accordance with the invention for shaping a signal,

FIG. 5 represents in a more general context a device in accordance with the invention for shaping an input signal that permits to separately process the shape and the gain of said signal, and

FIG. 6 represents an example of audio apparatus comprising a high impedance loudspeaker, and a device in accordance with the invention for shaping the speech signal applied to said loudspeaker.

### DESCRIPTION OF PREFERRED EMBODIMENTS

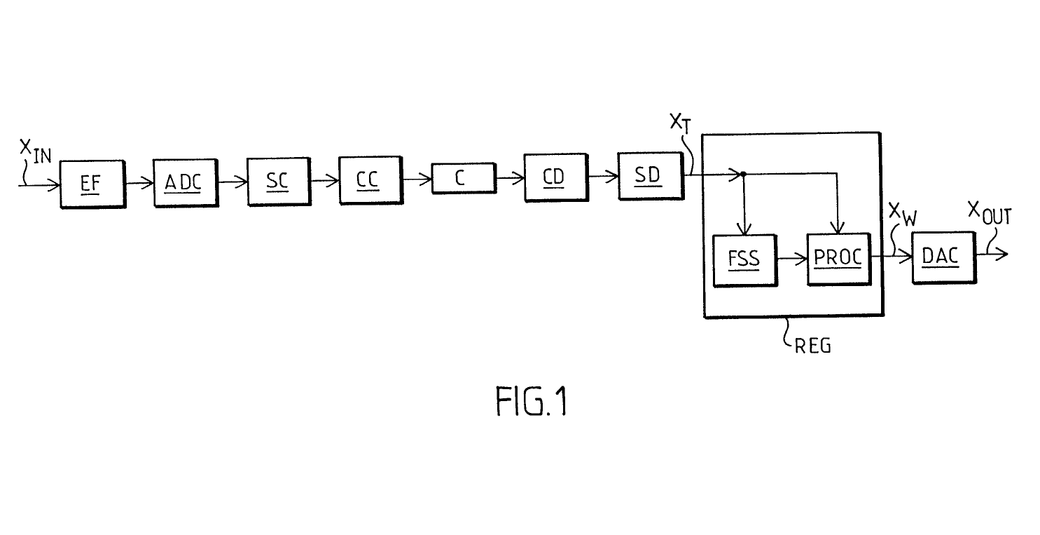

In FIG. 1 is shown in the shape of blocks a baseband model of a telephony transmission system. At the transmitter ES the speech signal X_{IN} is filtered by a transmit filter EF in the [300 Hz-3400 Hz] band, before it is applied to an analog to digital converter ADC, then to a source coder SC to reduce the quantity of data to be transmitted, and finally to a channel coder CC to protect the data to be transmitted. After transmission over the channel C the reverse operations are performed at the receiver RS: the transmitted signal is decoded by a channel decoder CD, then by a source decoder SD. A digital signal X_{T} is available on the output of the source decoder SD. This signal X_{T} is processed according to the invention by a signal shaping device REG. The device REG comprises selection means FSS for selecting a regeneration filter RF. The characteristics of the regeneration filter RF are transmitted to processing means PROC for processing the received signal X_{T}. The processing means PROC utilize the regeneration filter RF for delivering a regenerated speech signal X_{W}. The regenerated signal Xw is applied to a digital to analog converter DAC, which delivers an output signal X_{OUT}.

In the example described here, the selection means FSS implement a vector quantizer classification method. This is not restrictive and other classification methods may be applied, for example, a neuron-network-based method.

In a conventional manner, vector quantizer classification methods comprise a learning phase and a processing phase. The learning phase consists of establishing relations between elements of a start assembly and elements of an end assembly to establish classes, subsequently of associating characteristics to each of the classes that have been established. The processing phase consists of analyzing an input signal to classify same in one of the classes that have been established during the learning phase.

For more details of the vector quantizer techniques reference may be made to, for example, the article by Y. Linde, A. Buzo and R. M. Gray entitled “An algorithm for Vector Quantizer Design” and published in the periodical “IEEE Transactions on Communications”, vol. COM-28, no. 1, January 1980.

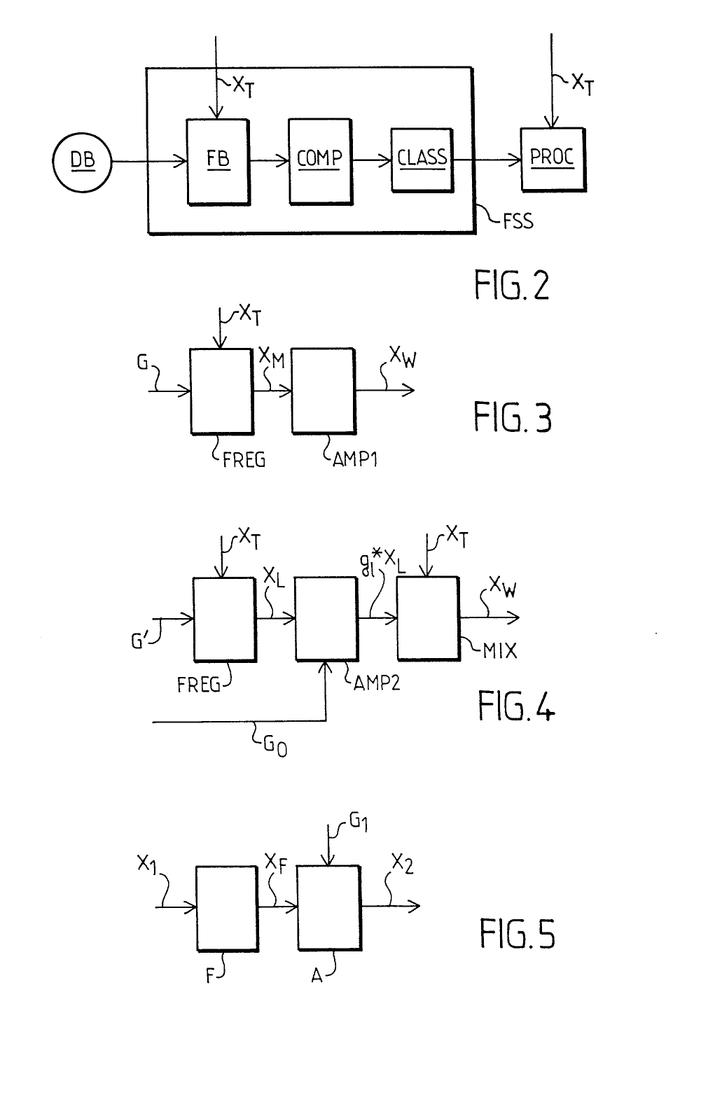

As indicated in FIG. 2, the selection means FSS utilize a filter bank FB whose function is to project the speech signal X_{T} in various frequency bands, for example, in the bands B1=[100 Hz-200 Hz], B2=[200 Hz-300 Hz] and B3=[300 Hz-1000 Hz]. A computation block COMP computes the energy E1, E2 and E3 in each of these bands, then determines ratios R1 and R2 between these energies: R1=E1/E3 and R2=E2/E3.

A classification is established during the learning phase when there is no communication. For this purpose, the signals of a speech signal database DB are applied to the filter bank FB. Then the energies E1, E2 and E3 and the ratios R1 and R2 are computed and stored for each signal.

Then various transmit filters are considered which may be used by a transmitter. And the signals of the database are filtered with these various filters before they are applied to the filter bank FB. Energies E1′, E2′ and E3′ and ratios R1′ and R2′ are then computed for each of the signals coming from the filter bank FB.

Correspondences are then established between the ratios R1 and R2, on the one hand, and the ratios R1′ and R2′, on the other. A quantification operation subsequently permits to regroup these correspondences to a certain number of classes. Then, for each class the characteristics of an optimal regeneration filter are defined.

When communication takes place, the received signal X_{T} is applied to the filter bank FB. The energies E1, E2 and E3 and the ratios R1 and R2 are computed for this received signal X_{T}. The ratios R1 and R2 are then used by a classification block CLASS to determine the class to which the received speech signal X_{T} belongs. The characteristics of a regeneration filter are associated to this class. These characteristics are transmitted by processing means PROC.

In a first embodiment represented in FIG. 3 the processing means PROC comprise filter means FREG. The size G of the regeneration filter to be used is transmitted to filter means FREG to filter the received signal X_{T}. The filter means FREG directly deliver a signal X_{M} in the [100 Hz-3400 Hz] band by amplifying only the low frequencies of the received signal X_{T}. In an advantageous manner the processing means PROC furthermore include an amplifier AMP1 which applies a variable gain to the signal X_{M} so as to obtain a regenerated speech signal X_{w}=g_{M}*X_{M}, which is non-saturated and has maximum dynamic. In the following of the description the saturation is considered to be reached when the amplitude of a signal exceeds +1 in absolute value. The gain g_{M} is thus written, for example as:

$${g}_{M} = min ( 1 , \frac{α}{{pic}_{M}} )$$

where α=0.95, for example, and where pic_{M} is the maximum value of the envelope of the signal X_{M}.

In a second embodiment represented in FIG. 4, the regeneration filter to be used is split up into a normalized regeneration filter (that is to say, having a maximum amplitude equal to 0 dB) and a constant gain Go. The processing means PROC moreover include filter means FREG, an amplifier AMP2 and a mixer MIX. The size G of the normalized filter is transmitted to the filter means FREG to filter the received signal X_{T}. The filter means FREG then produce a non-amplified signal X_{L} which occupies the low frequency band [100 Hz-300 Hz]. Furthermore, the constant gain Go is transmitted to the amplifier AMP2. And the amplifier AMP2 applies a variable gain g_{L} to the signal X_{L,} which variable gain is defined as follows:

$${g}_{L} = min ( {G}_{o} \frac{α}{{pic}_{L}} )$$

where pic_{L} is the maximum value of the envelope of the signal X_{L}.

The mixer MIX mixes the amplified signal g_{L}*X_{L} and the received signal X_{T} to deliver a regenerated speech signal XW. Preferably, the mixer MIX introduces a variable gain g_{w} for the amplified signal g_{L}*X_{L} and for the received signal X_{T}, so that the regenerated speech signal is written as:

X_{W}−g_{W}*g_{L}*X_{L}+g_{W}*X_{T}.

The gain g_{w} is defined, for example, as follows:

$${g}_{W} = min ( 1 , \frac{α}{{g}_{L} * {pic}_{L} + {pic}_{T}} )$$

where pic_{T} is the maximum value of the envelope of the signal X_{T}.

In this second embodiment the shape and the gain of the regenerated signal are processed separately, which permits the control of the gain to obtain maximum dynamic while saturation of the signal is avoided. This embodiment is particularly well adapted to receivers that use fixed-accuracy processors.

All the means that have just been described in the form of a block diagram are advantageously constituted by one or various program elements, stored in the memory of a microprocessor assembly and intended to be executed by said processor.

In FIG. 5 is shown in a more general context a device for shaping an input signal, which device permits to separately process the shape and the gain of said signal, to obtain maximum dynamic while saturation is avoided. This device comprises a normalized filter F and a variable amplifier A. The normalized filter F filters an input signal X₁ without amplifying it and the filter supplies a filtered signal X_{F} to the amplifier A. The amplifier A applies a variable gain g_{F} to the filtered signal X_{F}, which variable gain depends on a constant gain G₁ and on the maximum value pic_{F} of the envelope of the filtered signal. If the saturation is considered to be reached when the amplitude of a signal exceeds +1 as an absolute value, the variable gain g_{F} is written as, for example:

$${g}_{F} = min ( {G}_{1} , \frac{α}{{pic}_{F}} )$$

with α=0.95. The amplifier A delivers a non-saturated signal X₂ whose dynamic is maximum.

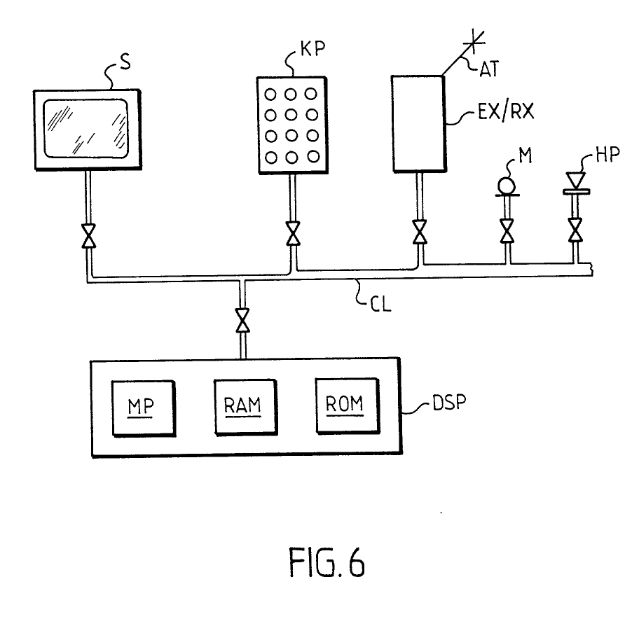

In FIG. 6 is represented an example of audio apparatus, comprising a device for shaping a speech signal in accordance with the invention. This apparatus is a mobile telephone with a microphone M, a keypad KP, a screen S, a high impedance loudspeaker HP, an antenna AT, a transceiver assembly EX/RX and a microprocessor assembly DSP, which are connected by a common line CL. The microprocessor assembly DSP manages the operation of the apparatus. It comprises a microprocessor MP, a random-access memory RAM and a read-only memory ROM. In the read-only memory ROM are notably stored operation programs of the apparatus, notably a program for utilizing the device for shaping a speech signal according to the invention. This program is intended to be executed by the microprocessor MP just before the microprocessor transmits a speech signal to the high impedance loudspeaker. Then, the low part of the frequency band of the speech signal is raised a priori, before the transmission of the signal to the loudspeaker. The attenuation of the low frequencies of the speech signal on the output of the high impedance loudspeaker is consequently reduced.

1. A transmission system comprising at least a transmitter (ES) for transmitting a speech signal (X_{IN}) in a narrow frequency band, and a receiver (RS) for receiving said speech signal, characterized in that said receiver comprises selection means (FSS) for selecting a regeneration filter (FREG) based on the received signal (X_{T}), and processing means (PROC) for processing the received signal with said regeneration filter to regenerate a frequency band that is low relative to said narrow band.

2. A transmission system as claimed in claim 1, characterized in that said processing means comprise analysis and classification means (FB, COMP, CLASS) for analyzing and classifying the received signal to establish a correspondence between said received signal (X_{IN}) and a regeneration filter (FREG).

3. A transmission system as claimed in claim 1, characterized in that the characteristics of the regeneration filter are such that the regeneration filter does not amplify any frequency and delivers a signal (X_{L}) that occupies only said low band, and in that said processing means comprise variable amplifying means (AMP2) for the signal delivered by the regeneration filter, to produce a non-saturated filter that has maximum dynamic (g_{L}*X_{L}), and combining means (MIX) for combining the signal thus amplified and the received signal (X_{T}) in the narrow band so as to produce a regenerated speech signal (X_{W}).

4. A transmission system as claimed in claim 3, characterized in that said combining means introduce a variable gain (g_{W}) for the amplified signal (g_{L}*X_{L}) and for the received signal (X_{T}) to produce a non-saturated regenerated speech signal that has maximum dynamic (X_{W}).

5. A receiver comprising receiving means for receiving a speech signal transmitted in a narrow frequency band, characterized in that it comprises selection means (FSS) for selecting a regeneration filter (FREG) based on the received signal (X_{T}), and processing means (PROC) for processing the received signal with said regeneration filter to regenerate a frequency band that is low relative to said narrow frequency band.

6. A receiver as claimed in claim 5, characterized in that the characteristics of the regeneration filter are such that the regeneration filter does not amplify any frequency and delivers a signal (X_{L}) that occupies only said low band, and in that said processing means (PROC) comprise variable amplification means (AMP2) for amplifying the signal delivered by the regeneration filter to produce a non-saturated signal that has maximum dynamic (g_{L}*X_{L}), and combining means (MIX) for combining the thus amplified signal (g_{L}*X_{L}) and the received signal (X_{T}) in the narrow band to produce a regenerated speech signal (X_{W}).

7. A device for shaping an input signal (X_{T}, X₁), characterized in that it comprises filter means for filtering without amplification (FREG, F1) to deliver a first output signal (X_{L}, X_{F}) and variable amplification means (AMP2, A) for amplifying said first output signal as a function of its maximum amplitude (pic_{L}, pic_{F}) to deliver a second non-saturated output signal (g_{L}*X_{L}, X₂) which has maximum dynamic.

8. A device for shaping a speech signal occupying a certain frequency band and which signal may be attenuated at least on a low part of said frequency band, characterized in that it comprises selection means (FSS) for selecting a filter (FREG) based on said speech signal, and processing means (PROC) for processing said speech signal with said filter to raise a frequency band that is low relative to said narrow band.

9. A method of processing a speech signal transmitted in a narrow frequency band, characterized in that it comprises a selection step (FSS) for selecting a regeneration filter (FREG) based on the received signal (X_{T}), and a processing step (PROC) for processing the received signal with said regeneration filter to regenerate a frequency band that is low relative to said narrow band.

10. A method of processing a speech signal as claimed in claim 9, characterized in that the characteristics of the regeneration filter are such that the regeneration filter does not amplify any frequency and delivers a signal (X_{L}) that occupies only said low band, and in that said processing step comprises a variable amplification step (AMP2) for amplifying the signal delivered by the regeneration filter, to produce a non-saturated signal that has maximum dynamic (g_{L}*X_{L}), and a combining step (MIX) for combining the thus amplified signal and the received signal in the narrow band to produce a regenerated speech signal (X_{W}).
